(19) United States
(12) Patent Application Publication
(10) Pub. No.: US 2016/0101010 A1
(43) Pub. Date: Apr. 14, 2016

(54) PHYSIOTHERAPEUTIC ENERGY WAVE GENERATING DEVICE

(71) Applicant: Yuan HSU, Taipei City (TW)

(72) Inventor: Yuan HSU, Taipei City (TW)

(21) Appl. No.: 14/548,108

(22) Filed: Nov. 19, 2014

(30) Foreign Application Priority Data
Oct. 9, 2014 (TW) 103218003

(51) Int. Cl. A61H 1/00; A61H 23/00

(52) U.S. Cl. CPC A61H 1/005; A61H 23/00

(57) ABSTRACT

A physiotherapeutic energy wave generating device consists of a control unit, a first conductive element, at least a second conductive element, an input unit, an energy wave generating unit, and a current limiting element. Wherein, the input unit couples the control unit to receive an adjustment instruction of the physiotherapist and transmit the adjustment instruction to the control unit; the energy wave generating unit also couples the control unit to generate a physiotherapeutic energy wave under control of the control unit according to the adjustment instruction and output the physiotherapeutic energy wave via the first conductive element and the second conductive element; the current limiting element is disposed between the energy wave generating unit and the first conductive element to limit energy intensity of the physiotherapeutic energy wave so as to avoid the patient having uncomfortable feeling or being in danger. Therefore, it can be operated very conveniently and safely.

### BACKGROUND OF THE INVENTION

1. Field of the Invention

The present invention is related to a health care equipment, and particularly to a physiotherapeutic energy wave generating device.

2. Brief Description of the Related Art

Along with evolution of civilization, the human life is getting stressful and busy, and the pace of daily lives become very compact. Although works of most people are substantially less laborious than before, the compact pace of daily lives make our physical and mental fatigues worse than before. As a result, regardless maintenance of physiological function or mental health, it is often to rely on assistance of the commercially available health care equipment.

Although many kinds of conventional health care equipment have been employed by physiotherapists to treat patients instead of traditional massages or acupunctures in order to relax bodies and minds so as to mitigate fatigue symptoms of the patients, the conventional health equipment is operated inconveniently with less effectiveness. Hence, how to ameliorate the deficiencies of the conventional health equipment is a subject worth us to care.

### SUMMARY OF THE INVENTION

Accordingly, an object of the present invention is to provide a physiotherapeutic energy wave generating device which is operated very safely and conveniently with excellent massage touch, and is capable of being operated by the patients themselves selectively to perform the physiotherapy.

In order to achieve the preceding object, the physiotherapeutic energy wave generating device according to present invention is suitable for being operated by a physiotherapist to treat a patient. The physiotherapeutic energy wave generating device includes a control unit, a first conductive element, at least a second conductive element, an input unit, an energy wave generating unit and a current limiting element.

Wherein, the input unit couples the control unit to receive an adjusting instruction of the physiotherapist and transmit the adjusting instruction to the control unit; the energy wave generating unit also couples the control unit to generate a physiotherapeutic energy wave under control of the control unit according to the adjusting instruction and output the physiotherapeutic energy wave via the first conductive element and the second conductive element; the current limiting element is disposed between the energy wave generating unit and the first conductive element to limit energy intensity of the physiotherapeutic energy wave so as to avoid the patient having uncomfortable feeling or being in danger.

In a preferred embodiment, the physiotherapeutic energy wave generating device is disposed at a location by a platform where the patient lies on, and there are provided with a plurality of the second conductive elements. Wherein, the first conductive element is provided on the platform for being closely touched by the patient lying on the platform, and the second conductive elements are disposed to surround the bottom of the platform for being stamped by the physiotherapist while the physiotherapeutic energy wave generating device is in operation such that the output physiotherapeutic energy wave can be guided into the acupuncture points of the patient via the body and hand pressing of the physiotherapist to accomplish the best physiotherapeutic effect.

In a preferred embodiment, the first conductive element is a conductive cloth woven with fibers containing copper and chrome; the respective second conductive element is composed of an insulation base with a conductive surface provided on the insulation base, and the conductive surface is made of copper or conductive rubber.

In a preferred embodiment, the adjustment instruction of the physiotherapeutic energy wave generating device includes adjusting energy intensity of the physiotherapeutic energy wave, adjusting real time of the control unit, and adjusting time setting to generate the physiotherapeutic energy wave such that the physiotherapist can regulate magnitude of the generated physiotherapeutic energy wave properly in accordance with physiotherapeutic condition so as to enhance effect of the physiotherapy, and regulate the real time and to control if the physiotherapeutic energy wave is generated based on the real time and the time setting. In addition, the adjustment instruction of the physiotherapeutic energy wave generating device can be selectively generated via a remote control to facilitate operation of the physiotherapist. Under the circumferences, a remote control receiver in the input unit is employed to receive the adjustment instruction issued by the remote control.

In a preferred embodiment, the physiotherapeutic operation can be selectively done by the physiotherapist with a massage handle of the physiotherapeutic energy wave generating device to enhance massage tactile impression of the patient, or it can be self-operated by the patient to perform the massage therapy as well. Under the circumferences, no second conductive elements are required, and the massage handle is used instead. The massage handle consists of a handgrip, a conductive disk, a soft conductive ball and an outer sleeve ring.

Wherein, the handgrip has a holding end and a massage end, and the massage end has a receiving part. The conductive disk is disposed in the receiving part of the handgrip to discharge the physiotherapeutic energy wave generated by the host member. The soft conductive ball is disposed to closely touch the conductive disk when the outer sleeve ring fits with the massage end to achieve the effect of the massage therapy and provide excellent massage tactile impression.

In a preferred embodiment, the handgrip of the massage handle of the physiotherapeutic energy wave generating device has an annular projection at the outer surface thereof, and the outer sleeve ring is provided with an annular groove corresponding to the annular projection such that the outer sleeve ring can fit with the massage end firmly in favor of operation.

In a preferred embodiment, the conductive disk of the massage handle of the physiotherapeutic energy wave generating device is a copper disk to enhance the effect of guiding the physiotherapeutic energy wave. The soft conductive ball is a wet sponge or cotton ball to offer better operational touch, and is selectively wrapped firmly with a piece of cloth sandwiched between the outer sleeve ring and the handgrip.

In a preferred embodiment, the physiotherapeutic energy wave generating device further comprises an output unit coupling the control unit to display energy intensity of the output physiotherapeutic energy wave, real time of the control unit, and time setting to generate the physiotherapy energy wave.

In summary, it is appreciated that the physiotherapy energy wave generating device according to the present invention provides a current limiting element between the energy wave generating unit and the first conductive element to limit the energy intensity of the physiotherapeutic energy wave so as to avoid the patient to be subject to uncomfortable feeling or danger caused by excess energy intensity of the output physiotherapeutic energy wave. Further, the second conductive elements are arranged around the bottom of the platform which the patient lies on, and the physiotherapist is able to movably stamp on the second conductive elements randomly such that it is very convenient for the physiotherapist to operate the physiotherapy energy wave generating device. Besides, the massage handle, which has a soft conductive ball such as the sponge ball or cotton ball, is capable of contacting the body of the patient with better operational touch to meet the needs of different users and allowing the patient to self-operate the massage therapy selectively.

### BRIEF DESCRIPTION OF THE DRAWINGS

The detail structure, the applied principle, the function and the effectiveness of the present invention can be more fully understood with reference to following description and accompanying drawings, in which:

FIG. 1 is a perspective view of a preferred embodiment of a physiotherapeutic energy wave generating device according to the present invention;

FIG. 2 is a block diagram illustrating circuits of the host member of the physiotherapeutic energy wave generating device shown in FIG. 1;

FIG. 3 is a perspective view illustrating operation of the physiotherapeutic energy wave generating device shown in FIG. 1;

FIG. 4 is a partly exploded perspective view of the massage handle shown in FIG. 1;

FIG. 5 is a sectional view of the massage handle shown in FIG. 1;

FIG. 6 is a perspective view illustrating a piece of cloth for covering the massage handle shown in FIG. 1.

### DETAILED DESCRIPTION OF THE INVENTION

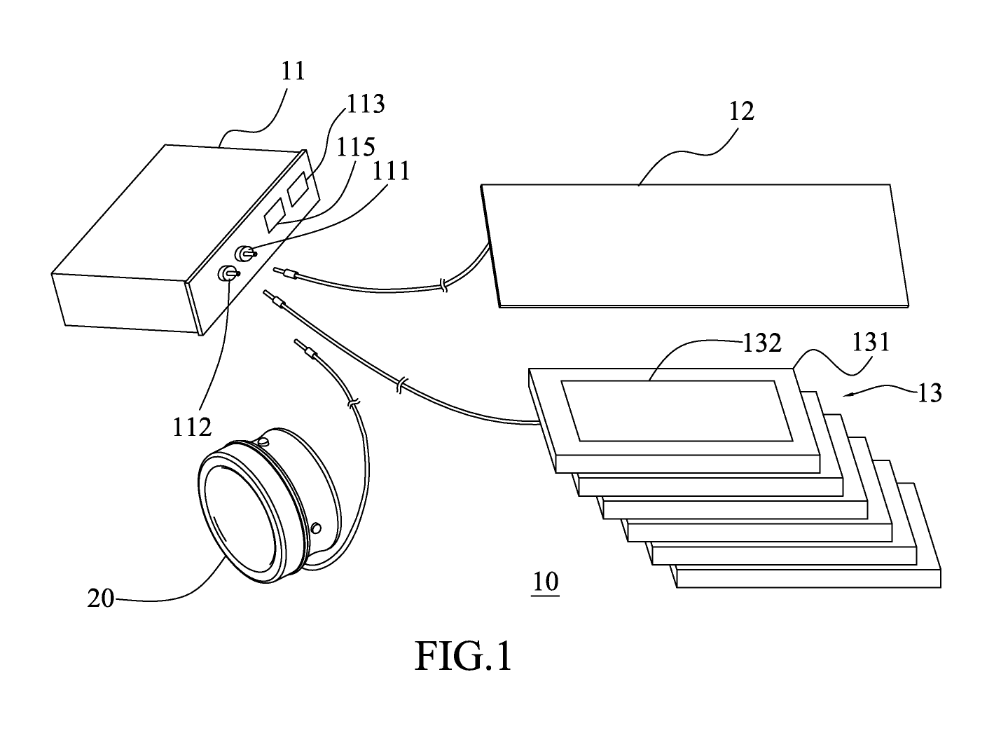

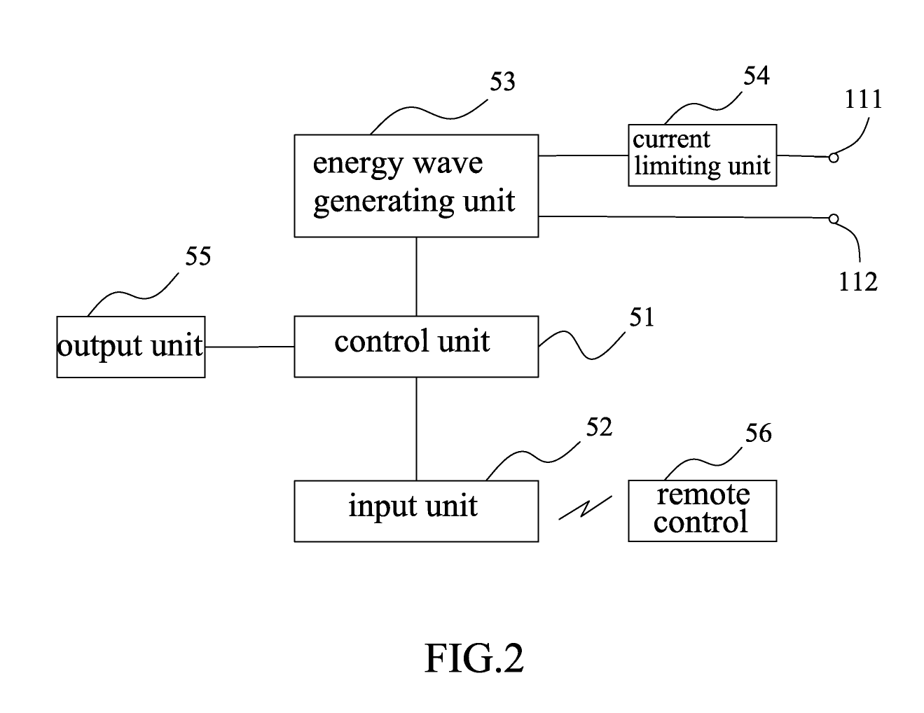

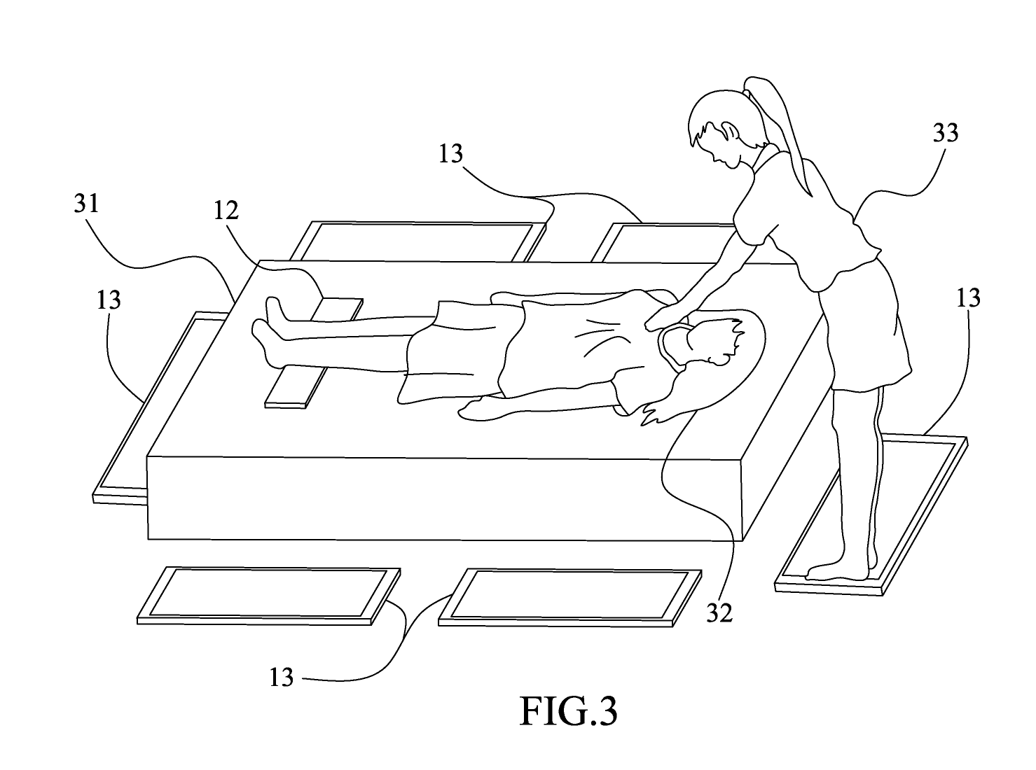

Referring to FIGS. 1 to 6, a preferred embodiment of a physiotherapeutic energy wave generating device according to the present invention is illustrated. It can be seen in FIG. 3 that the physiotherapeutic energy wave generating device 10 is applicable for being operated by a physiotherapist 33 to treat a patient 32.

It can be seen in FIGS. 1 to 3 that the physiotherapeutic energy wave generating device 10 comprises a host member 11, a first conductive element 12, at least a second conductive element 13, a remote control 56, and a massage handle 20, wherein the host member 11 consists of a control unit 51, an input unit 52, an energy wave generating unit 53, a current limiting unit 54 and an output unit 55. The host member 11 further comprises an adjustable panel 113 disposed in the input unit 52, a display 115 disposed in the output unit 55, and a first plug end 111 and a second plug end 112 which connect the first conductive element 12 and the second conductive element 13 respectively.

Wherein, the first conductive element 12 is a conductive cloth woven with fibers containing copper and chrome; the respective second conductive element 13 has an insulation base 131 with a conductive surface 132 provided on the insulation base 131, and the conductive surface 132 is made of copper or conductive rubber. The massage handle 20 will be recited in detail afterward.

The input unit 52 shown in the figures couples the control unit 51 to receive an adjustment instruction of the physiotherapist 33 and transmit the adjustment instruction to the control unit 51. The energy wave generating unit 53 couples the control unit 51 as well to generate physiotherapeutic energy wave under control of the control unit 51 and output the physiotherapeutic energy wave via the first conductive element 12 and the second conductive element 13. The current limiting element 54 is disposed between the energy wave generating unit 53 and the first conductive element 12 to limit energy intensity of the physiotherapeutic energy wave so as to avoid the patient 32 having uncomfortable feeling or being in danger caused by excessive energy intensity of the physiotherapeutic energy wave.

When the physiotherapeutic energy wave generating device is in use, the physiotherapist 33 can selectively operate the adjustable panel 113 or the remote control 56 in accordance with physiotherapeutic condition to regulate the generated physiotherapeutic energy wave properly based on an adjustment instruction for the energy intensity of the physiotherapeutic energy wave so as to enhance physiotherapeutic effect. The physiotherapeutic energy wave usually are low potential and low frequency alternate electrical signals to stimulate acupuncture points of the patient 32 so as to achieve an effect similar to electronic acupuncture.

Besides, the physiotherapist 33 can selectively operate the adjustable panel 113 or the remote control 56 to regulate the real time of the physiotherapeutic energy wave generating device 10 and to adjust time setting for generating the physiotherapeutic energy wave such that the control unit 51 is capable of controlling if the physiotherapeutic energy wave is generated based on the real time and the time setting. As for the energy intensity of the output the physiotherapeutic energy wave, the real time and the time setting can be shown on the display 115 selectively.

It can be seen in FIG. 3 that the physiotherapeutic energy wave generating device 10 is disposed at a location by a platform 31 where the patient 32 lies on, and there are provided with a plurality of the second conductive elements 13. Wherein, the first conductive element 12 is provided on the platform 31 to connect with the plug end 111 of the host member 11 for the patient 32 being able to closely touch during lying on the platform 31. The second conductive elements 13 are disposed to surround the bottom of the platform 31 and connected to the second plug end 112 for being stamped by the physiotherapist 33 during operating the physiotherapeutic energy wave generating device such that the output physiotherapeutic energy wave of the host member 11 can be guided into the acupuncture points of the patient 32 via the body and hand pressing of the physiotherapist 33 to reach the best effect of the physiotherapy. When the physiotherapist 33 moves to operate another part of the body of the patient 32, the corresponding second conductive element 13 is stamped by the physiotherapist 33 for the physiotherapeutic work being performed randomly.

Besides, when massage therapy is performed, it can be selectively done by the physiotherapist 33 or the patient 32 via holding the massage handle 20; under the circumferences, it is not necessary to use the second conductive elements 13, and, instead, the massage handle 20 is connected to the second plug end 112.

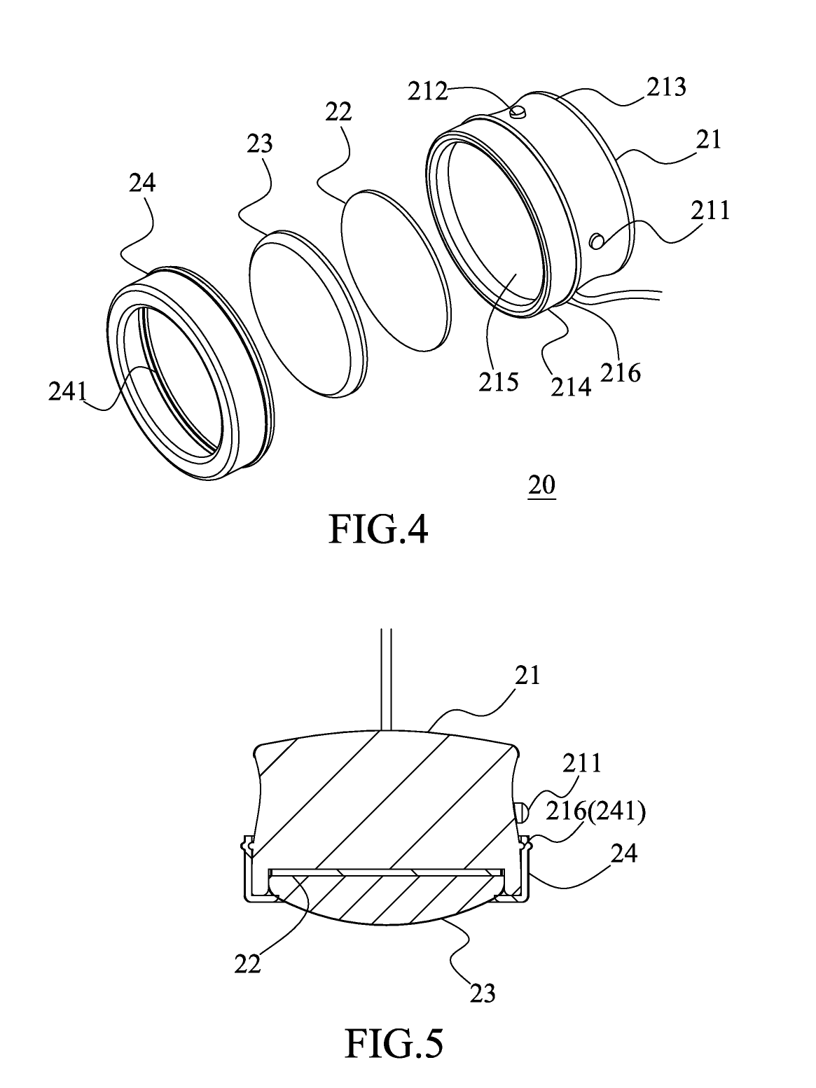

Please referring to FIGS. 4 and 5, the massage handle 20 comprises a handgrip 21, a conductive disk 22 such as a copper disk, a soft conductive ball 23 such as a wet sponge ball or cotton ball, and an outer sleeve ring 24. Besides, in order to allow the operator to be able to control the physiotherapeutic energy wave generating device 10 more conveniently, the handgrip 21 is provided with a weak switch 211 and an enhanced switch 212 additionally for the output physiotherapeutic energy wave of the host member 11 capable of being adjusted to weak mode or enhanced mode.

Wherein, the handgrip 21 has a holding end 213 and a massage end 214, and there is a recessed receiving part 215 at the massage end 214. The outer surface of the handgrip 21 has an annular projection 216, and the inner surface of the outer sleeve ring 24 has an annular groove 241 corresponding to the annular projection 216 such that the handgrip 21 and the outer sleeve ring 24 fit with each other firmly while the annular projection 216 engaging with the annular groove 24f. Of course, the outer sleeve ring 24 also can be tightly fitted with the handgrip 21 as it is known by persons familiar with the art; under the circumferences, it is not necessary to provide the annular projection 216 and the annular groove 241.

The conductive disk 22 is disposed in the receiving part 215 of the handgrip 21 to discharge the physiotherapeutic energy wave generated by the host member 11 and output via the second plug end 112. The soft conductive ball 23 is also disposed in the receiving part 215 of the handgrip 21 to closely touch the conductive disk 22 when the outer sleeve ring 24 fits with the massage end 214 of the handgrip 21.

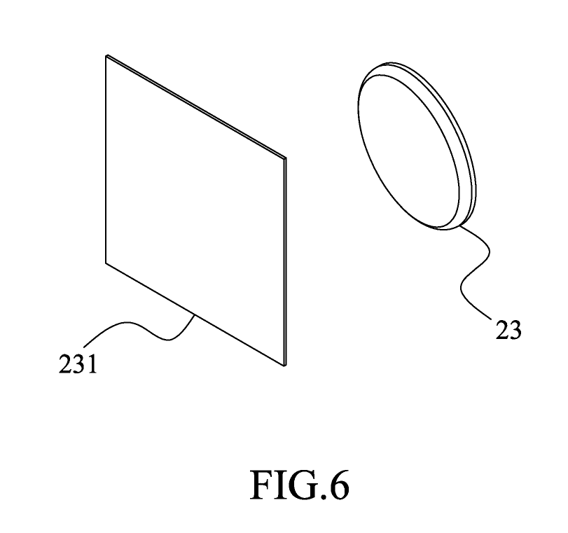

In addition to the engaging way shown in FIGS. 4 and 5, in order to retain the soft conductive ball 23 such as the wet sponge ball or cotton ball in the handgrip 21 more securely, an alternative is illustrated in FIG. 6 that a piece of cloth 231 such as cotton cloth or non-woven cloth is employed to wrap the soft conductive ball 23 before the conductive ball 23 is placed in the handgrip 21, and the piece of cloth 231 with the soft conductive ball 23 is sandwiched between outer sleeve ring 24 and the handgrip 21. In this way, the soft conductive ball 23 can be prevented from falling off when the massage is exerted with a pushing force.

While the invention has been described with referencing to the preferred embodiments thereof, it is to be understood that modifications or variations may be easily made without departing from the spirit of this invention which is defined by the appended claims.

What is claimed is:

1. A physiotherapeutic energy wave generating device, which is applicable for being operated by a physiotherapist to treat a patient, comprising:
a control unit;
a first conductive element;
at least a second conductive element;
an input unit coupling said control unit to receive an adjustment instruction of the physiotherapist and transmit the adjustment instruction to the control unit;
an energy wave generating unit coupling the control unit to generate a physiotherapeutic energy wave under control of the control unit according to the adjustment instruction and output the physiotherapeutic energy wave via the first conductive element and the second conductive element;
a current limiting element disposed between said energy wave generating unit and said first conductive element to limit energy intensity of the physiotherapeutic energy wave.

2. The physiotherapeutic energy wave generating device as defined in claim 1 is disposed at a location by a platform where the patient lies on, and further comprising a plurality of the second conductive elements; the first conductive element is provided on the platform to be closely touched by the patient lying on the platform; the second conductive elements are disposed to surround the bottom of the platform to be stamped by the physiotherapist during performing physiotherapeutic operation.

3. The physiotherapeutic energy wave generating device as defined in claim 1, wherein the first conductive element is a conductive cloth woven with fibers containing copper and chrome.

4. The physiotherapeutic energy wave generating device as defined in claim 1, wherein the respective second conductive element further comprising:
an insulation base; and
a conductive surface, which is provided on the insulation base, being made of copper or conductive rubber.

5. The physiotherapeutic energy wave generating device as defined in claim 1, wherein said adjustment instruction includes adjusting energy intensity of the physiotherapeutic energy wave, adjusting real time of said control unit, and adjusting time setting for generating the physiotherapeutic energy wave.

6. The physiotherapeutic energy wave generating device as defined in claim 1, wherein said input unit has a remote controlled receiver to receive said adjustment instruction via a remote controlled operation.

7. The physiotherapeutic energy wave generating device as defined in claim 1 further comprising a massage handle which further comprising:
a handgrip having a holding end and a massage end with a recessed receiving part at the massage end;
a conductive disk disposed in the receiving part to discharge the physiotherapeutic energy wave;
a soft conductive ball is disposed at the receiving part;
an outer sleeve ring fitting with said massage end to allow the soft conductive ball to closely touch the conductive disk firmly.

8. The physiotherapeutic energy wave generating device as defined in claim 7, wherein the outer surface of the handgrip has an annular projection, and the inner surface of the outer sleeve ring has an annular groove corresponding to the annular projection.

9. The physiotherapeutic energy wave generating device as defined in claim 7, wherein the conductive disk is a copper disk, and the soft conductive ball is a wet sponge or cotton ball.

10. The physiotherapeutic energy wave generating device as defined in claim 9 further comprising a piece of cloth sandwiched between said outer sleeve ring and said handgrip.

11. The physiotherapeutic energy wave generating device as defined in claim 1 further comprising an output unit coupling said control unit to display energy intensity of the physiotherapeutic energy wave, real time of said control unit, and time setting for generating the physiotherapeutic energy wave.
